(19) United States
(12) Patent Application Publication
(10) Pub. No.: US 2012/0215636 A1
(43) Pub. Date: Aug. 23, 2012

(54) FINANCIAL INSTITUTION BYPASS OF DISTRIBUTION CHANNELS

(75) Inventor: Erik Stephen Ross, Charlotte, NC (US)

(73) Assignee: BANK OF AMERICA CORPORATION, Charlotte, NC (US)

(21) Appl. No.: 13/030,913

(22) Filed: Feb. 18, 2011

(51) Int. Cl. G06Q 30/00; G06Q 90/00

(52) U.S. Cl. 705/14.53; 705/500; 705/1.1

(57) ABSTRACT

Embodiments of the invention are directed to facilitating a direct purchase of products between a provider and potential customer that bypasses the traditional product distribution channels for a customer purchase, and more particularly embodiments of the invention are directed to methods, apparatuses, and computer program products for providing a financial institution based bypass program that enables bypass of a traditional distribution channel for a customer's product purchase by linking customers of the financial institution with product providers.

### BACKGROUND

A traditional product distribution channel, in its basic form, generally includes a manufacturer, a distributor, a retailer, and a customer. A product is created by a manufacturer and then channeled to one or more distributors. The distributors may provide the product to a variety of retailers. The retailer, in turn, advertises and sells the product to a customer.

Each of the steps along the channel typically involves a price increase of the product in relation to the previous step of the channel. For example, a distributor may receive a product from a manufacturer at a specific price. Then the distributor will sell the product to a retailer for an increased price, to cover the over head of the distributor and to generate a profit. Therefore, each of the members of the distribution channel will receive a monetary benefit from the product as it passes through the channel. By the time it reaches the customer, the price of the product may be significantly higher than the original manufacturer price. Although there is a price increase at each step of the distribution channel, the channel is in place for several reasons. Primarily, there is little benefit for a manufacturer to sell products directly to a customer. This is because the customer does not typically purchase enough products from the manufacturer to make the transaction economically feasible for the manufacturer. Further, the customer would have to buy directly from several different manufacturers, which would significantly burden the customer. Also, the burden of advertising to customers directly from the manufacturer is likely less efficient than advertising at the retail level. To this end, there is always a demand for a manufacturer to provide products to its customers in the most cost beneficial way.

### BRIEF SUMMARY

Embodiments of the present invention address the above needs and/or achieve other advantages by providing apparatuses (e.g., a system, computer program product, and/or other devices) and methods for a financial institution program to bypass the traditional distribution/sales channels, which allows a financial institution to provide purchase offers to customers for products that the customers wish to purchase, directly from the manufacturer. In some embodiments the financial institution mines data to determine products that a customer will likely purchase or products that a customer shows interest in purchasing. In some embodiments the financial institution is provided input from the customer as to products the customer will likely purchase.

Embodiments of the invention allow a customer to purchase a product from a manufacturer through a financial institution provided bypass offer, at a discounted price. The financial institution may receive information regarding a customer in the form of customer data. Customer data may include financial institution data and/or inputted data. In some embodiments the financial institution may mine data it has regarding the customer's purchase interests. Financial institutions have large amounts of customer data to provide bypass offers specific to the customer, because they maintain or administer their customers' various financial accounts (i.e., credit card account, checking account, savings account, etc.) and because they have data related to their customers' purchases. Financial institutions may track and store data related to what products their customers purchased, when their customers made the purchases, how much the customers spent, what merchants the customers used to make the purchases, etc. for both online and offline purchases. This data uniquely positions the financial institution to provide customers with offers for products that the customer intends to purchase. For example, a financial institution may determine that a customer uses his credit card to purchase a specific brand of clothing regularly. Using the credit card data, the financial institution may then provide the customer with a bypass offer from the manufacturer of that clothing.

In some embodiments the customer may provide input to the financial institution as to products the customer is planning to purchase. These inputs may take the form of surveys, wish lists, questionnaires, inputs via an interface, sensor data from products, sensor data from customers, customer inventorying and tagging, global positioning system data, wearable computer data, social networks, etc.

Customer inputs are compiled with the financial institution data to provide the financial institution with a list of customers willing to purchase a specific type of product. For example, the customer may respond to a survey indicating that he is wishing to purchase a television and not specify the manufacturer. The financial institution may utilize customer input data and financial institution data to determine a bypass offer. For example, the customer has made several transactions for electronics, all from the same manufacturer, in the last five years. The financial institution may combine this data with customer input data indicating that the customer is wishing to purchase a television, to provide the customer with a bypass offer for a television from the manufacturer that the customer traditionally purchases from.

In some embodiments customer inputs may be used to provide a bypass offer to the customer. For example, a customer may respond to a survey indicating that he is wishing to purchase a television from a manufacturer. The financial institution may use this survey data to provide a bypass offer for a television from the manufacturer. In some embodiments financial institution data may be used to provide a bypass offer to a customer.

Furthermore, financial institutions also have direct ties with many different manufacturers that use the financial institutions for their own financial needs. In one embodiment the financial institution may mine data regarding the products a manufacturer produces to provide a customer with a bypass offer of a product from the manufacturer. For example, the financial institution may receive information related to the financial transactions of a manufacturer, in turn, the financial institution may have knowledge that the manufacturer produces textiles. The financial institution may then provide, from the customer data, a list of seventy customers that are willing to purchase the manufacturer's textiles directly. The manufacturer may then provide the seventy customers with the textiles at a discounted price, largely because the textiles are bypassing the traditional distribution/sales channels. In some embodiments the manufacturer may input data regarding products they may wish to sell through the bypass offer. These inputs may take the form of surveys, questionnaires, sensor data, inputs via an interface, etc. For example, a manufacturer may be willing to provide some products to customers through the bypass offer program. However, the manufacturer may wish to limit the products available. Therefore, the manufacturer may provide the financial institution with a list of products available from them for the bypass offer program. A subset of one of these categories is where the financial institution gathers manufacturer data based on its analysis of customer interest. Specifically, by analyzing the customers' interest, the financial institution may determine various products of interest to customers.

The financial institution compiles the customer data, data from the financial institution, and customer inputted data to determine the customer's future purchases. In one embodiment the financial institution may then contact the manufacturer of the products of interest to negotiate a bypass offer for such products. In this manner, the financial institution may actively negotiate bypass offers with manufacturers based on a review of customer interest. In this sense, analysis of the customer interest allows the financial institution to identify products of interest and then actively seek bypass offers from manufacturers of such products. In one embodiment the financial institution proceeds to compile the product information data, data from the financial institution and manufacturer inputted data regarding products available from a manufacturer for the bypass offer program to determine a group of customers who may purchase a product from a manufacturer. Once a group of customers is determined, the financial institution may provide the customers with a bypass offer for the product and facilitate a transaction between the customers and the manufacturer for the product.

More particularly, embodiments of the present invention are directed to a method, system, and computer program product for promoting sales of products generally offered through distribution channels comprising, receiving customer data associated with one or more customers obtained through interaction with customer via a financial institution, determining from the customer data a potential interest by one or more of the customers in a given product, and facilitating a transaction between the customer and a seller, independent of the distribution channels for the product.

In further accord with an embodiment of the invention receiving information data associated with at least one of the products generally offered through distribution channels, wherein said determining a potential interest comprises using the information data to determine from the customer data potential interest by one or more customers in the given product.

In further accord with an embodiment of the invention determining an offer to the one or more customers based at least in part on the determined potential interest. Determining an offer may further comprises negotiating with a seller of the products a price, rebate, and/or discount.

In further accord with an embodiment of the invention the distribution channels include distribution from a manufacturer to a retailer with a plurality of possible intermediary steps. In one embodiment the plurality of possible intermediary steps is a distributor. In one embodiment the seller is one of a manufacturer of the product or an intermediate distributor of the product.

In further accord with an embodiment of the invention customer data associated with one or more customers is based on data acquired by interaction between the financial institution and the one or more customers. In one embodiment receiving customer data associated with one or more customers is obtained through customer input.

In further accord with an embodiment of the invention the financial institution may receive product information data associated with at least one of the products generally offered through distribution channels. In one embodiment product information data is based on data acquired by interaction between the financial institution and the seller of the product. In one embodiment product information data is based on data inputted by the seller.

In further accord with an embodiment of the invention determining the potential interest by one or more of the customers in a given product includes determining from the customer data one or more products purchased previously by one or more customers. Determining the potential interest further comprises determining from the customer data one or more products that one or more customers wish to purchase. In one embodiment an offer to one or more customers is based at least in part on the determined potential interest. The offer comprises negotiating with a seller of the products a price, a rebate, and/or a discount. The offer further comprises calculating a compatibility of the customer data and the product information data, wherein the calculation is a comparison of the likelihood that a customer will purchase a product to the products available from a seller.

In further accord with an embodiment of the invention facilitating a transaction between the customer and a seller, who is the manufacturer of products, includes receiving an offer from the seller and providing the offer to the one or more customers. In one embodiment a transaction fee may be charged to either one or both the customer and the seller of the products.

In further accord with an embodiment of the invention facilitating a transaction between the customer and a seller, who is the manufacturer of products, includes receiving an offer from the seller and providing the offer to the one or more customers.

### BRIEF DESCRIPTION OF THE DRAWINGS

Having thus described embodiments of the invention in general terms, reference will now be made the accompanying drawings, wherein:

FIG. 1 provides a high level process flow illustrating a bypass offer program process for providing a bypass offer to a customer, in accordance with one embodiment of the present invention;

FIG. 2 provides a bypass offer program system and environment, in accordance with one embodiment of the present invention;

FIG. 3 provides a data process flow illustrating how customer data and product information data is used in the process, in accordance with one embodiment of the present invention;

FIG. 4 provides a bypass offer program decision process flow illustrating customer and manufacturer decisions, in accordance with one embodiment of the present invention;

FIG. 5 provides a bypass offer program bypass offer interface, in accordance with one embodiment of the present invention;

FIG. 6 provides a bypass offer program manufacturer bypass offer interface, in accordance with one embodiment of the present invention;

FIG. 7 provides a bypass offer program manufacturer confirmation bypass offer interface, in accordance with one embodiment of the present invention; and

FIG. 8 provides a bypass offer program bypass offer acceptance interface, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, as used herein, the term “product” shall mean any good, service, event, etc. that may be offered by a manufacturer. In addition, the term “bypass offer” is used herein to denote any form of offer, promotion, rebate, coupon, incentive, and/or the like offered for the purchase, lease, and/or the like of a product. A “transaction” as used herein may refer to a purchase, lease, barter, and/or any other form of transfer of product from a manufacturer to a customer. Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution.

This disclosure is written in terms of creating bypass offers directly from a manufacturer to offer to a customer. It is understood that the invention is meant to provide some form of incremental sales channel and should not be limited to a manufacturer-end customer scenario. The invention is meant to provide bypass offers from sellers to customers. The seller may be a manufacturer or a down channel distributor. The customer may be an end customer or another intermediate down channel distributor.

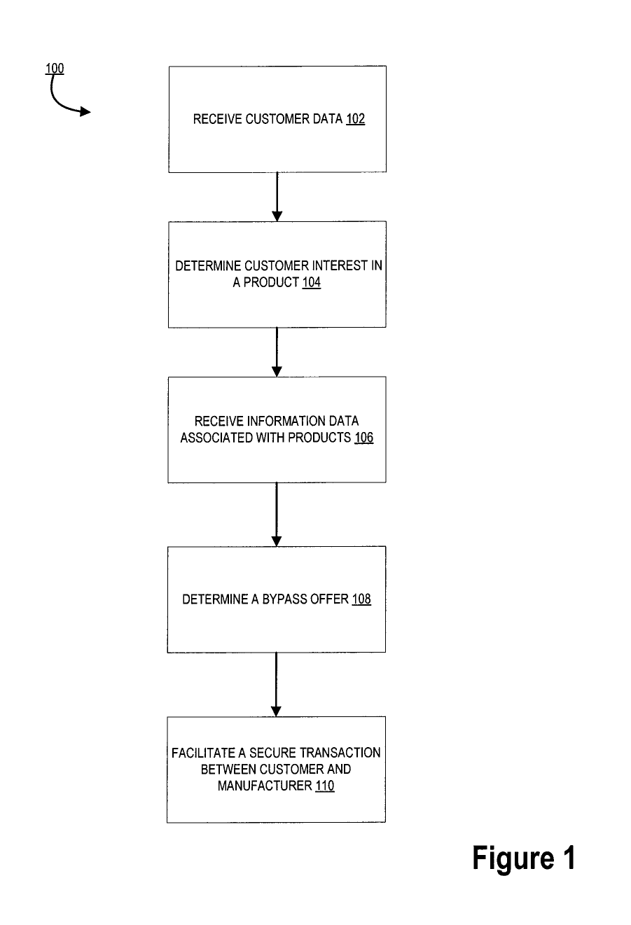

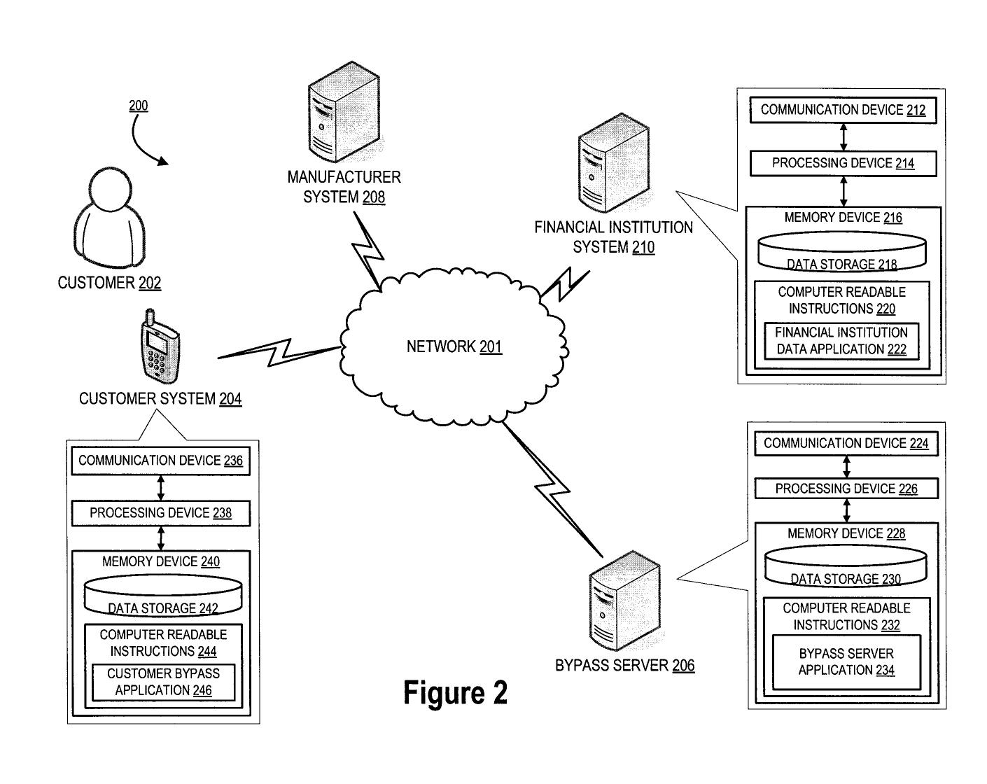

FIG. 1 illustrates a high level process flow illustrating a bypass offer program process 100 for providing a bypass offer to a customer 202, which will be discussed in further detail throughout this specification with respect to FIG. 2 through FIG. 8. As illustrated in block 102, the bypass offer program process 100 according to one embodiment includes receiving, at the financial institution, customer data. The financial institution systems utilize the received customer data 102 to determine the customer's interest in a product, as illustrated in block 104. As illustrated in block 106, the bypass offer program process 100 includes receiving, at the financial institution, product information data that is associated with products from a manufacturer. Thereafter, the financial institution systems use the customer data received 102 and the product information data received 106 to determine a bypass offer, as illustrated in block 108. After a bypass offer has been determined 108, the financial institution may facilitate a secure transaction between a customer 202 and manufacturer for a product purchased through the bypass offer program, as illustrated in block 110.

FIG. 2 provides a bypass offer program system environment 200, in accordance with one embodiment of the present invention. As illustrated in FIG. 2, the bypass server 206 is operatively coupled, via a network 201 to the manufacturer system 208, the financial institution system 210, and the customer system 204. In this way, the bypass server 206 can send and receive information to and from the manufacturer system 208, the financial institution system 210, and the customer system 204, to facilitate the creation of a bypass offer. FIG. 2 illustrates only one example of an embodiment of a bypass offer program system and environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination of wireline and wireless communication between devices on the network.

In some embodiments the customer 202 is an individual that has financial accounts with a financial institution and may desire to receive bypass offers for products through the financial institution. The accounts the customer 202 has at the financial institution may include any accounts available at the financial institution for individual customers 202, such as but not limited to savings accounts, checking accounts, credit card accounts, investment accounts, retirement accounts, mortgage accounts, etc. In some embodiments of the invention the customer 202 is a merchant that has financial accounts with a financial institution and desires to receive a bypass offer for products through the financial institution. In this way, the merchant may receive products from a manufacturer without being directed through traditional distribution channels. The accounts the merchant has at the financial institution may include any accounts available at the financial institution for merchant customers 202, such as but not limited to customer accounts, lease agreements, business accounts, brokerage accounts, expense accounts, etc. Depending on the embodiment, use of customer account information for the bypass offer program may be based on an “opt in” response from the customer 202. The customer 202 may choose to enter only certain accounts into the program or all of their accounts. Alternatively, the customer 202 may not wish to use any of his account information for the bypass offer program but instead, use only data gathered from the customer 202 via surveys, questionnaires, communities, groups, etc. selected by the customer as part of the program.

As illustrated in FIG. 2, the bypass server 206 generally comprises a communication device 224, a processing device 226, and a memory device 228. As used herein, a “processing device” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 226 is operatively coupled to the communication device 224 and the memory device 228. The processing device 226 uses the communication device 224 to communicate with the network 201 and other devices on the network 201, such as, but not limited to the manufacturer system 208, the financial institution system 210, and the customer system 204. As such, the communication device 224 generally comprises a modem, server, or other device for communicating with other devices on the network 201.

As illustrated in FIG. 2, the bypass server 206 comprises computer-readable instructions 232 stored in the memory device 228, which in one embodiment includes computer-readable instructions 232 for a bypass server application 234. In some embodiments, the memory device 228 includes data storage 230 for storing data related to the bypass offer program including, but not limited to the data created and/or used by the bypass server application 234.

As illustrated in FIG. 2 and described throughout much of this specification, the bypass server application 234 allows for customer data and product information data to be utilized to determine a bypass offer. The data stored within the bypass server application 234 provides computer readable instructions 232 to the processing device 226 to allow for the determination of bypass offers. The bypass server application 234 stores or accesses information for the development of the bypass offer including, but not limited to, customer data and product information data.

In one embodiment, the bypass server application 234 allows for customer data to be used as input into the determination of a particular bypass offer to be made. The customer data may be in the form of customer inputted data, customer financial institution data, or a combination thereof. In one embodiment, as explained in further detail below, customer input data may include any data provided by the customer 202 to the financial institution for an indication as to customer 202 purchase plans, such as products the customer 202 intends to purchase, products the customer 202 wishes to purchase, or products the customer 202 will purchase. For example, the customer input data may be in the form of survey data, questionnaire data, wish list data, or provided through a bypass offer interface 500. The data could be information gathered from customer selections of “likes,” organizations they indicate affiliation with, and the like. In one embodiment, the customer inputted data may be data provided by sensors related to the product. For example, a sensor may indicate that a customer 202 may be running out of a product. The sensor may provide this data, as customer data to determine a bypass offer, knowing that the customer 202 may be needed more of the product. This example may provide for automatic replenishment of products. A sensor may be associated with the product or a sensor may be provided by the customer 202. A customer 202 provided sensor may be an inventory documentation or picture that may be included for determination of a bypass offer. In another example, the bypass server application 234 allows the customer 202 to communicate, via the customer system 204, to indicate products the customer 202 may purchase by providing survey data.

In one embodiment, as explained in further detail below, customer financial institution data includes financial data that the financial institution system 210 may collect independent of the bypass offer program. For example, customer financial data may include customer accounts such as checking accounts, savings accounts, investment accounts, credit card accounts, etc. and other financial information, such as mortgage information, loan information, payment information, etc. The customer financial institution data may provide the bypass server application 234 an indication of the customer's 202 prior spending, in order to predict possible purchase plans, such as products the customer 202 intends to purchase, products the customer 202 wishes to purchase, or products the customer 202 will purchase. In one example, the bypass server application 234 allows the financial institution system 210 to communicate customer financial institution data, such as purchase information from a specific financial institution account, such as a credit card.

In one embodiment the bypass server application 234 allows for product information data to be utilized to determine a bypass offer. The product information data may be in the form of manufacturer input data or manufacturer financial institution data. A subset of one of these categories is where the financial institution gathers manufacturer data based on its analysis of customer interest. Specifically, by analyzing the customer interest data, the financial institution may determine various products of interest to customers. The financial institution may then contact a manufacturer of the products of interest to negotiate a bypass offer for such products. In this manner, the financial institution may actively negotiate bypass offers with manufacturers based on a review of customer interest. In this sense, analysis of the customer interest allows the financial institution to identify products of interest and then actively seek bypass offers from manufacturers of such products.

In one embodiment, as explained in further detail below, manufacturer input data may include any data provided by the manufacturer to the financial institution for an indication as to manufacturer products, availability of a product for the bypass offer program, and the price of the product. For example, the manufacturer input data may be in the form of survey data, questionnaire data, product data, or provided through a manufacturer bypass offer interface 600. In one example, the bypass server application 234 allows the manufacturer to communicate, via the manufacturer system 208, to indicate products the manufacturer may provide to the bypass offer program.

In one embodiment, as explained in further detail below, manufacturer financial institution data includes financial data that the financial institution system 210 may collect independent of the bypass offer program. For example, manufacturer financial data may include manufacturer accounts, such as business accounts, credit accounts, business checking accounts, etc., other financial information, such as lines of credit, leases, mortgages, loans, product data, marketing strategies, etc., and also individual manufacturer data such as specific products sold, products that may be available for the bypass offer program, and product pricing. This manufacturer financial institution data may provide the bypass server application 234 an indication of the manufacturer's product line, in order to predict possible products available for the bypass offer program, such as products the manufacturer is willing to provide to the bypass offer. In one example, the bypass server application 234 allows the financial institution system 210, to communicate manufacturer financial institution data, such as product price information from a specific financial institution account.

As illustrated in FIG. 2, the financial institution system 210 is generally comprised of a communication device 212, a processing device 214, and a memory device 216. The processing device 214 uses the communication device 212 to communicate with the network 201 and other devices on the network 201, such as, but not limited to the bypass server 206, the customer system 204, and the manufacturer system 208. As such, the communication device 212 generally comprises a modem, server, or other device for communicating with other devices on the network 201.

As illustrated in FIG. 2, the financial institution system 210 comprises computer-readable instructions 220 stored in the memory device 216, which in one embodiment includes computer-readable instructions 220 for a financial institution data application 222. In some embodiments, the memory device 216 includes data storage 218 for storing data related to the bypass offer program including, but not limited to customer financial information, manufacturer financial information, and data created and/or used by the financial institution data application 222.

In the embodiment illustrated in FIG. 2, the financial institution data application 222 comprises financial information of both the customer 202 and the manufacturer. In one embodiment the financial information of the customer 202 received by the financial institution data application 222 comprises information that the customer 202 currently has with the financial institution. For example, if the customer 202 has a savings account and a checking account with the financial institution, the information related to these accounts may be stored in the financial institution data application 222. Therefore, the bypass server 206 may use the account information already available at the financial institution to create bypass offers relative to the customer's 202 prior purchase habits, without the customer 202 having to manually input data for the bypass program.

As illustrated in FIG. 2, the customer system 204 is generally comprised of a communication device 236, a processing device 238, and a memory device 240. The customer system 204 is a computing system that allows a user to provide information for the bypass offer program, via a network 201, to the bypass server application 234. Further, the customer system 204 allows the customer 202 to view both the financial institution interface and the offer interface. The processing device 238 is operatively coupled to the communication device 236 and the memory device 240. The processing device 238 uses the communication device 236 to communicate with the network 201 and other devices on the network 201, such as, but not limited to the manufacturer system 208, the bypass server 206, and the financial institution system 210. As such, the communication device 236 generally comprises a modem, server, or other device for communicating with other devices on the network 201.

As further illustrated in FIG. 2, the customer system 204 comprises computer-readable instructions 244 stored in the memory device 240, which in one embodiment includes computer-readable instructions 244 for a customer bypass application 246. In this way, a customer 202 may be able to access both the bypass offer interface and/or the bypass offer acceptance interface. The bypass offer interface allows a customer 202 to add information about products the customer 202 is wishing to purchase, is planning to purchase, or will purchase in the future. The bypass offer acceptance interface allows the customer 202 to view a bypass offer that is made to the customer 202. Further, the bypass offer acceptance interface allows a customer 202 to accept or decline a bypass offer. In some embodiments, the memory device 240 includes data storage 242 for storing data related to the bypass offer program including, but not limited to customer input data, customer financial data, and data created and/or used by the customer bypass application 246. The customer system 204 may be, for example, a desktop personal computer, a mobile system such as a laptop, a personal digital assistant (“PDA”), a cellular phone, a smart phone, or the like. Although only a single customer system 204 is depicted in FIG. 2, the bypass offer program system and environment 200 may contain numerous customer systems 204.

The manufacturer system 208 is operatively coupled to the financial institution system 210, the bypass server 206, and/or the customer system 204 through the network 201. The manufacturer system 208 has systems with devices the same or similar to the devices described for the financial institution system 210, the bypass server 206 and the customer system 204 (i.e., a communication device, a processing device, and a memory device). Therefore, the manufacturer system 208 communicates with the financial institution system 210, the bypass server 206, and/or the customer system 204 in the same or similar way as previously described with respect to each system. The manufacturer system 208, in some embodiments, is comprised of systems and devices that allow the financial institution system 210 and the bypass server 206 to access financial information and product information regarding the manufacturer. The manufacturer system 208, in some embodiments, is further comprised of systems and devices that allow the manufacturer system 208 to receive and respond to manufacturer interfaces sent via a network 201 from the bypass server application 234 of the bypass server 206. Although only a single manufacturer system 208 is depicted in FIG. 2, the bypass offer program system and environment 200 may contain numerous manufacturer systems 208.

It is understood that the servers, systems and devices described herein illustrate one embodiment of the invention. It is further understood that one or more of the servers, systems, and devices can be combined in other embodiments and still function in the same or similar way as the embodiments described herein.

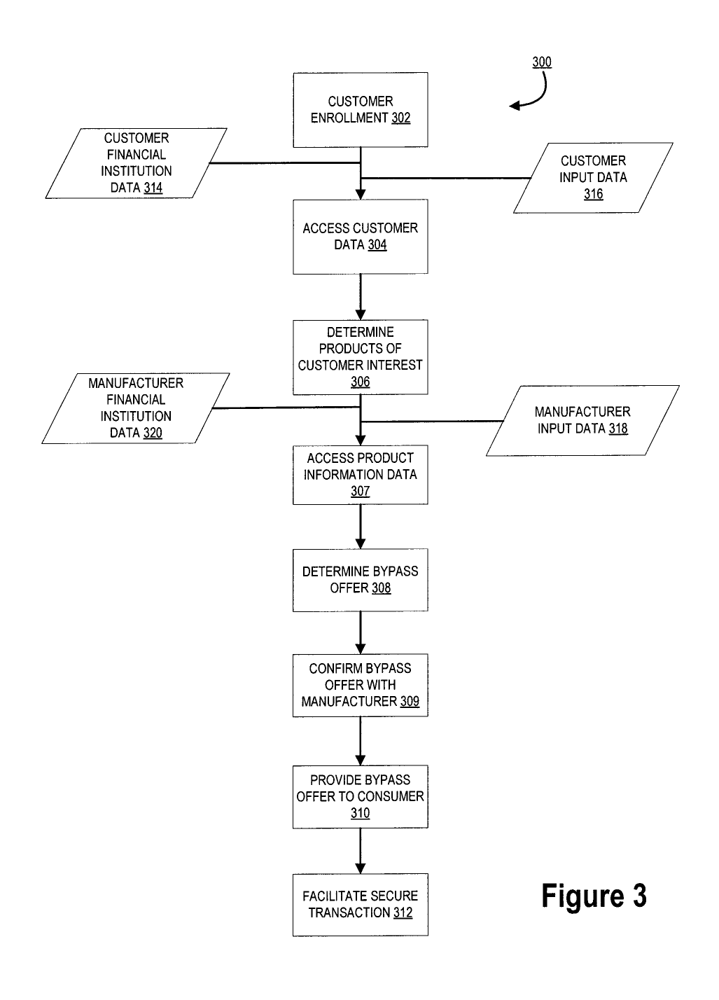

FIG. 3 illustrates a data process flow 300 of how customer data and product information data are implemented to determine bypass offers. As illustrated in block 302, in this illustrated embodiment, the bypass program initiates upon customer enrollment 302 in the program. In some embodiments of the invention the customer 202 may enroll by accessing an online banking interface with a customer system 204. In other embodiments of the invention the customer 202 may enroll by visiting a financial institution branch. In other embodiments of the invention the customer 202 may not enroll in the bypass program, however because of the loyalty of the customer 202 to the financial institution, the financial institution may determine to offer the customer 202 bypass offers. In other embodiments of the invention the customer 202 may have to purchase enrollment into the bypass offer program.

Once a customer 202 has enrolled 302, the bypass server application 234 is allowed access to customer data, as illustrated in block 304. In some embodiments of the invention the customer data may be customer financial institution data 314 received, by request from the bypass server application 234, from the financial institution data application 222. In some embodiments of the invention the customer 202 can input data 316 in order to specify products requested through the bypass offer program. Input data 316 may be requested by the bypass server application 234 to the customer 202 through a customer system 204. In some embodiments of the invention the customer data received 304 may be a combination of customer financial institution data 314 and customer input data 316.

The customer financial institution data 314 includes customer account information and other financial information of the customer 202. Prior to receiving customer input data 316 from the customer 202, the financial institution system 210 is able to mine its own data to determine potential customer 202 purchase plans. In one embodiment, the customer account information may include all the customer accounts available to the customer through the financial institution. The customer 202 may have several accounts, including savings accounts, retirement accounts, checking accounts, investment accounts, or credit card accounts with the financial institution, these accounts may be included as customer financial institution data 314 to be used by the bypass server application 234 to determine appropriate bypass offers for the customer 202. For example, the customer 202 may purchase the majority of his electronics using a specific credit card. The information the financial institution system 210 receives regarding the transactions from the credit card may lead to a determination that the customer 202, when purchasing electronic equipment, purchases only a specific brand of electronic equipment. The bypass server application 234 may recognize the customer's 202 trend in purchasing electronic equipment and provide the customer 202 a bypass offer from the manufacturer of that brand.

In one embodiment, the other financial information may include all other financial information of the customer 202 available through the financial institution. The customer 202 may have mortgages, car loans, personal loans, transaction data, wish list data, purchase data, or payment plans, at the financial institution. This financial information may be included as customer financial institution data 314 to be used by the bypass server application 234 to determine appropriate bypass offers for the customer 202. Information associated with the other financial information such as personal information may help establish purchase plans of the customer 202. For example, the customer 202 may have a car loan with the financial institution. The information the financial institution system 210 receives regarding the car loan, such as the type of vehicle purchased with the loan, may lead to a determination that the customer 202 purchased a large truck. The bypass server 206 may recognize the customer's 202 large truck purchase and provide the customer 202 with a bypass offer from manufacturers of trailers and/or truck accessories. Alternatively, the customer 202 may have a mortgage with the financial institution. The information the financial institution system 210 receives regarding the mortgage, such as the geographic location of the house associated with the mortgage, may lead to a determination that the customer 202 has a mortgage for a house in a popular snow skiing geographic. The bypass server 206 may recognize the customer's 202 location and provide the customer 202 with a bypass offer from manufacturers of winter outdoor equipment.

In some embodiments of the invention the customer financial institution data 314 may be provided to the bypass server 206 after customer enrollment 302. In other embodiments of the invention the customer financial institution data 314 may be provided to the bypass server application 234 prior to customer enrollment 302.

The customer input data, as illustrated in block 316, may include data provided by the customer 202 as an indication to customer's 202 purchase plans. Purchase plans may include products the customer 202 intends to purchase, products the customer 202 wishes to purchase, or products the customer 202 will purchase. In one embodiment the customer 202 may provide purchase plan indications through survey data, questionnaire data, wish list data, or provided through a bypass offer interface 500. In this way, the bypass server application 234 allows the customer 202 to communicate, via the customer system 204, to indicate products the customer 202 may purchase by providing input with a bypass offer interface 500. In one embodiment the customer 202 may provide purchase plan indications through the mail, by telephone, or in person at a branch of the financial institution.

Customer input data may also be provided passively to the bypass offer system from social networks, online groups, chat rooms, organizational involvements, product sensors, etc. that the customer 202 has relationships with and that provide indications, data, etc. relating to preferences, likes, wishes, intentions, etc. of the customer 202 regarding products. For example, as a member of a social network, the customer 202 may select an interest in various companies, causes, events, products, etc. to define their profile and/or to receive updates with companies, organizations, individuals, etc. associated with such interests. Such selections may indicate a customer's 202 preferences for various products or indicate recent purchases, timing for replacement purchases for older products, etc. In another example, a sensor associated with a product may indicate that a customer 202 has no product left. The sensor may provide this data, as customer data to the bypass server application 234, knowing that the customer 202 may be needed more of the product. Data from a sensor may be customer 202 provided sensor such as an inventory documentation or picture that may be included for determination of a bypass offer. This type of customer input data can be used by the bypass server 206 to assess potential bypass offers to be made to the customer 202.

As illustrated in block 316, prior to the bypass server 206 determining products of customer interest 306, the customer 202 may supply several inputs that the customer 202 may want to include for consideration of a bypass offer. The customer 202 may provide information such as a specific product, a brand of product, or a generic name for a product. For example, the customer 202 may list a specific product, such as a 42-inch high definition flat screen television, a brand of a product, such as a Sony 42-inch high-definition flat screen television, or a generic name for a product, such as a television.

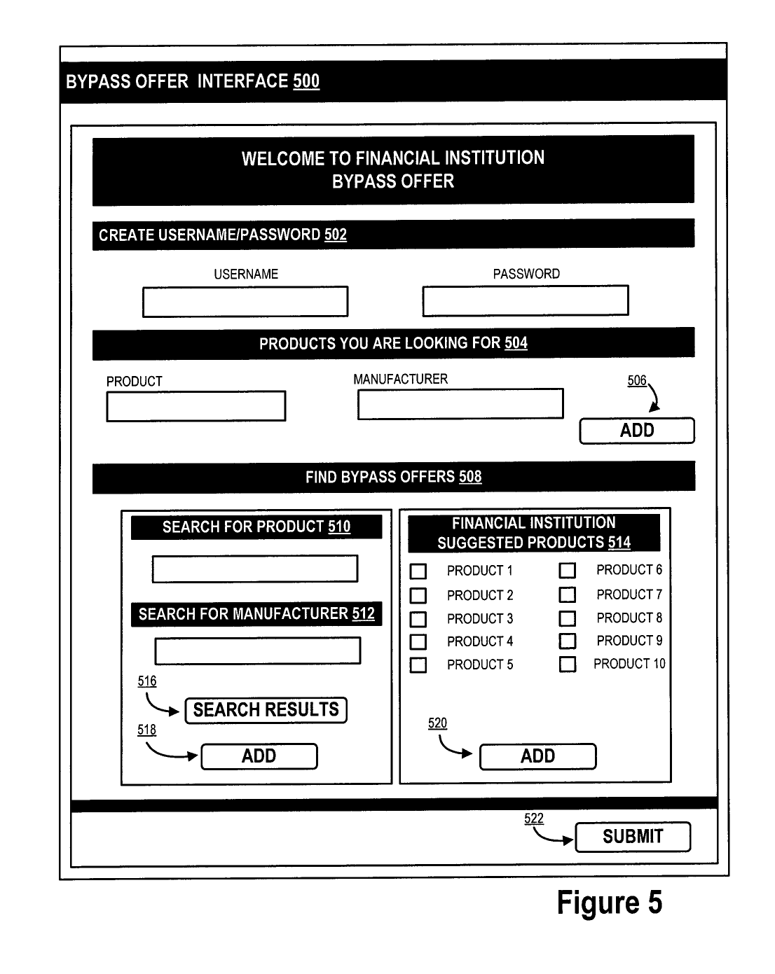

In one embodiment, the customer 202 may provide customer input data 316 through a bypass server application 234 provided bypass offer interface 500. As illustrated in FIG. 5, the bypass offer interface 500 may be provided to the customer 202 through an online banking application. The bypass offer interface 500 may be downloaded from the bypass server application 234, to the customer system 204, through a network 201. First, the customer 202 may create a username and password 502 or insert an existing username and password to gain access to the customer's 202 bypass offer program. Once a user name and password has been entered and confirmed by the bypass server application 234, the customer 202 may proceed to the products you are looking for section 504. In the products you are looking for section 504, the customer 202 may provide product and/or manufacturer data for products the customer 202 may wish to purchase. Once the customer 202 has inputted a product and/or manufacturer, the customer 202 may select add 506 thereby allowing the data to be directed, via a network 201, to the bypass server application 234. These products may be include products the customer 202 is wishing to purchase, but may not be purchasing in the near future. For example, the customer 202 may currently own a computer. However, the customer 202 may wish to eventually upgrade that computer. Therefore, the customer 202 may provide a new computer on the products you are looking for section 504, to be offered bypass offers of a new computer in the future.

Along with the customer 202 inputting product information in the products you are looking for section 504, the customer 202 may also select bypass offers from the find bypass offers section 508. Within the find bypass offer section 508, the customer 202 may search for products 510, search for manufacturers 512, or select from financial institution suggested products 514. In one embodiment the customer 202 may search for products in the search for products section 510. In the search for products section 510, the customer 202 may input products that the customer 202 is intending to purchase or products the customer 202 will purchase. For example, if the customer 202 is intending to purchase a new desk lamp, the customer may not know a specific manufacturer of desk lamps, therefore the customer may insert the term “desk lamp” into the search for products section 510. In one embodiment the customer 202 may search for manufacturers in the search for manufacturer section 512. In the search for manufacturer section 512 the customer 202 may input manufacturer's names that the customer 202 intends to purchase products from. For example, if the customer 202 always purchases a specific brand of clothing, the customer 202 may input that manufacturers name in the search for manufacturer section 512. Once the customer 202 has provided search criteria in the search for product section 510 or the search for manufacturer section 512 the customer 202 may select to view search results 516. After viewing the search results the customer 202 may select a bypass offer and add the bypass offer using the add button 518.

Also in the find bypass offers section 508, the customer 202 may select from financial institution suggested products in section 514. The financial institution suggested products 514 provides the customer 202 with a selection of products for the bypass offer. The financial institution suggested products 514 developed out of customer financial institution data 314 from the financial institution data application 222. If the customer 202 selects one of the suggested products, the customer 202 may select to add 520 the product to the bypass offers.

After the customer 202 has completed his selections from the bypass offer interface 500, the customer 202 may confirm his selections by selecting submit 522. For example, the customer 202 may have inputted on the products you are looking for section 504, that he will be interested in purchasing a computer. The customer 202 may also have inputted that he is currently looking to purchase clothing from a specific manufacturer in the search for manufacturer section 512. The customer 202 may have also selected product 2 from the financial institution suggested products section 514. If the customer 202 is satisfied with the selections he made, he submits 522 the selections. In this way, the bypass offer program may be able to distinguish between wish list products of the customer 202 in the products you are looking for section 504 and product the customer 202 is intending to purchase in the near future in the find bypass offers section 508. The completed bypass offer interface 500 is sent from the customer system 204 to the bypass system 206 through a network 201.

As illustrated in FIG. 3, once the customer financial institution data 314 and the customer input data 316 have been added to the data process flow 300, the next step is to determine products of customer 202 interest, in block 306. Using the customer financial institution data 314 and/or customer input data 316 the bypass server application 234 selects products that the customer 202 may be interested in for a bypass offer. In one embodiment the bypass server application 234 may use only the customer financial institution data 314 to determine products of customer interest 306. In one embodiment the bypass server application 234 may use only the customer input data 316 to determine products of customer interest 306. In one embodiment the bypass server application 234 may use both the customer financial institution data 314 and the customer input data 316 to determine products of customer interest 306.

As illustrated in FIG. 3 at block 307, the data process flow 300 is allowed access to product information data. In some embodiments of the invention the product information data may be manufacturer financial institution data 320 received by request from the bypass server application 234, from the financial institution data application 222. In some embodiments of the invention the product information data may be comprised of manufacturer input data 318. Product information data may be requested by the bypass server application 234 from the manufacturer through a manufacturer system 208. In some embodiments of the invention the product information data may be a combination of manufacturer financial institution data 320 and manufacturer input data 318.

The manufacturer financial institution data 320 includes data that the financial institution has regarding the manufacturer. Prior to receiving manufacturer input data 318 from the manufacturer, the financial institution system 210 is able to mine its own data to determine product data of the manufacturers. In one embodiment the financial institution data 314 may be financial account data of the manufacturer, such as business accounts, credit accounts, business checking accounts, etc. This data may be included as manufacturer financial institution data 320 to be utilized by the bypass server application 234. For example, the manufacturer may have a credit account with the financial institution, on the credit account there may be transactions for supplies to make bicycles. The information the financial institution system 210 receives regarding the transactions from the credit account may lead to a determination that the manufacturer manufactures bicycles. The bypass server application 234 may recognized the manufacturer's purchases and provide the customers 202 interested in bicycles a bypass offer.

In one embodiment the financial institution data 320 may include all other financial information the financial institution has with regard to the manufacturer. The manufacturer may have other financial information with the financial institution, such as lines of credit, leases, mortgages, loans, product data, advertisement and marketing strategies, etc. This data may be included as manufacturer financial institution data 314 to be utilized by the bypass server application 234. For example the manufacturer may provide the financial institution with information relating to payments made for advertising a product of the manufacturer. The information the financial institution system 210 receives regarding the payment for advertisement may provide for a determination that the manufacturer produces bicycles. The bypass server application 234 may recognized the advertising data and provide the customers 202 interested in bicycles a bypass offer from the manufacturer.

The manufacturer input data 318, may include product data provided by the manufacturer as an indication of which products the manufacturer may provide to a customer 202 through the bypass program. In one embodiment the manufacturer may provide manufacturer input data 318 through survey data, questionnaire data, or through a manufacturer bypass offer interface 600. In this way, the bypass server application 234 allows the manufacturer to communicate, via the manufacturer system 208, to indicate products that the manufacturer intends to provide for customers 202 through the bypass offer program by providing input on the manufacturer bypass offer interface 600. In one embodiment the manufacturer may provide manufacturer input data 318 for the bypass offer through the mail, by telephone, or in person at a branch of the financial institution. The manufacturer may provide manufacturer input data 318 about products of the manufacturer, products of the manufacturer for the bypass offer program, product information, and bypass offer product pricing. For example, the manufacturer may indicate that it manufactures all types of electronic equipment. However, the manufacturer may indicate that only stereo systems, gaming consoles, and computer products are going to be offered through the bypass offer program, not televisions.

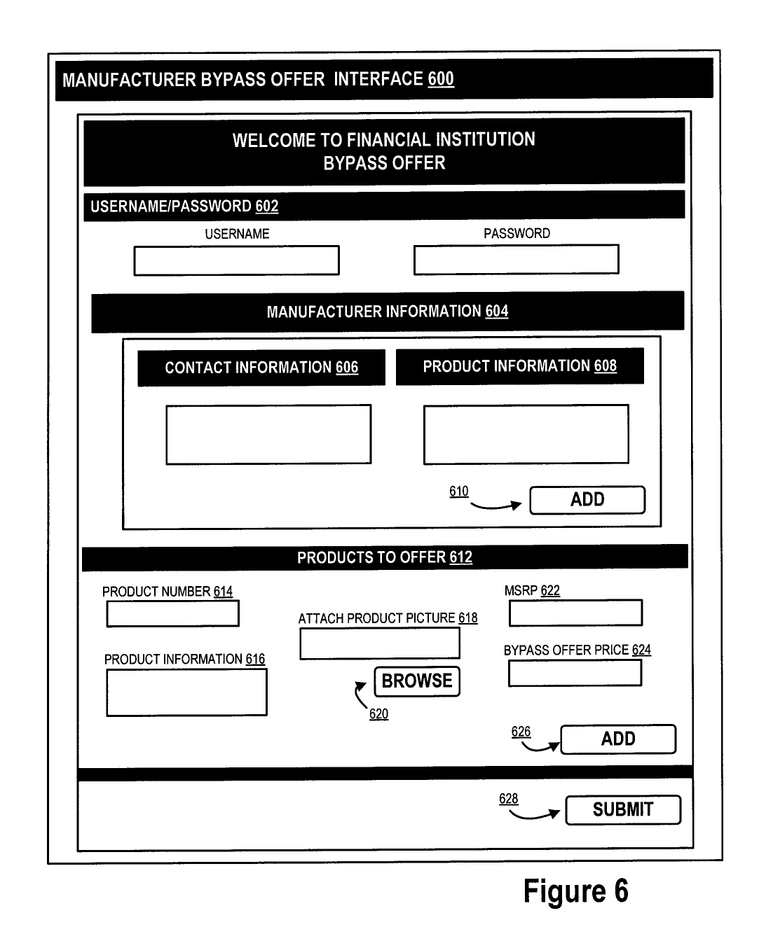

In one embodiment, the manufacturer may provide manufacturer input data 318 through a manufacturer bypass offer interface 600. As illustrated in FIG. 6, the manufacturer bypass offer interface 600 may be downloaded from the bypass server application 234 to the manufacturer system 208, through a network 201. First, the manufacturer may create a username and password 602 or insert an existing username and password to gain access to the bypass offer program. Once the user name and password have been entered and confirmed by the bypass server application 234, the manufacturer may proceed to the manufacturer information section 604. In the manufacturer information section 604 the manufacturer may input contact information 606. The contact information 606 may be, for example, an individual employee at the manufacturer whom the financial institution may contact in regards to the bypass offer program. Also within the manufacturer information section 604, the manufacturer may provide product information 608. Product information 608 may be, for example, any products that the manufacturer produces exclusive of the products offered for the bypass offer program. Once the manufacturer has added all of the contact information 606 and/or the product information 608, the manufacturer may select add 610 to add the information to the manufacturers input data 318.

Along with the manufacturer information 604 the manufacturer bypass offer interface 600 allows the manufacturer to provide products it is willing to offer to customers 202 through the bypass offer program in the products to offer section 612. At the products to offer section 612, the manufacturer may provide detailed information regarding products the manufacturer may offer through the bypass offer program. For example, the manufacturer may provide a product number 614, additional product information 616, the manufacturers suggested retail price (“MSRP”) 622, and the bypass offer price 624. Further, the manufacturer may attach a product picture 618 by selecting browse 620 and downloading a picture from the manufacturer system 208. Once the manufacturer has inputted into the products to offer section 612, the manufacturer may select add 626 thereby allowing the data to be directed, via a network 201, to the bypass server application 234. In one embodiment of the invention the manufacturer is provide an incentive to participate in the program by being guaranteed a lift in revenue due to enrollment in the program.

After the manufacturer has completed its selections from the manufacturer bypass offer interface 600, the manufacturer may confirm its selections by selecting submit 628. For example, the manufacturer may have added an individual contact for the bypass offer program, added all products the manufacturer produces, and limited the number of products available to a customer 202 through the bypass offer program.

As shown in FIG. 3, manufacturer product information may be determined by mining manufacturer financial institution data 320 or by manufacturer input data 318. A subset of one of these categories is where the financial institution gathers manufacturer data based on its analysis of customer interest 306. Specifically, by analyzing the customer interest data 306, the financial institution may determine various products of interest to customers. The financial institution may then contact a manufacturer of the products of interest to negotiate a bypass offer for such products (see determine bypass offer 308 below). In this manner, the financial institution may actively negotiate bypass offers with manufacturers based on a review of customer interest 306. In this sense, analysis of the customer interest 306 allows the financial institution to identify products of interest and then actively seek bypass offers from manufacturers of such products.

As illustrated in FIG. 3, once the manufacturer financial institution data 320 and the manufacturer input data 318 have been added to the data process flow 300, the next step is to determine a bypass offer in block 308. In one embodiment, determining the bypass offer 308 may include calculating a compatibility of the customer's 202 interest in a product compared to products the manufacturers are offering through the bypass offer program. The compatibility is a comparison of the likelihood a customer 202 will purchase a product compared to the products availability from a manufacturer. In one embodiment the compatibility is calculated by the bypass server application 234 by incorporating the customer data 304 and the product information data 307. For example, if the customer 202 indicates that he is willing to purchase a 42-inch Sony high-definition flat panel television, the bypass server application 234 may take this data into consideration. However, if Sony is not a manufacturer associated with the bypass offer program, the bypass server application 234 may provide the customer 202 a bypass offer of another manufacturer's 42-inch high-definition flat panel television.

As illustrated in FIG. 3, if a bypass offer was determined in block 308, then the offer must be confirmed by the manufacturer in block 309. In one embodiment if a bypass offer is determined to correspond with customer data 304 and product information data 307, the bypass server application 234 will ensure the manufacturer is still willing to provide the product through the bypass offer program. In one embodiment, confirming the bypass offer with the manufacturer 309 may include the manufacturer system 208 receiving a confirmation bypass offer interface 700 from the bypass server application 234, via a network 201. In one embodiment, confirming the bypass offer with the manufacturer 309 may include the financial institution receiving confirmation of the bypass offer by telephone, mail, fax, or from a manufacturer representative.

After confirming the bypass offer with the manufacturer in block 309, the offer is provided to the customer 202, in block 310. In one embodiment the bypass offer is rejected by the customer 202. If the customer 202 rejects the bypass offer provided to him then the bypass offer will remain in his bypass offer program for a predetermined time period, because the bypass offer matched customer data and/or product information data there is a potential for the customer 202 to be interested in the bypass offer at a later time. In one embodiment the bypass offer is accepted by the customer 202. At this point the transaction may be facilitated, as illustrated in block 312. Because of the financial institution's unique position with respect to the customer 202 and the manufacturer the transaction facilitated in block 312 is within a secure framework. Thus providing the manufacturer and the customer 202 fraud protection and confidence when executing a transaction using the bypass offer program. In one embodiment the customer 202 and/or the manufacturer may pay an enrollment fee when the bypass offer is accepted by the customer 202, in block 310. In one embodiment the customer 202 and/or the manufacturer may pay an enrollment fee at the time of enrollment. In one embodiment the customer 202 and/or the manufacturer may not pay an enrollment fee for the bypass offer program. In one embodiment, if a customer 202 and/or manufacturer provide for a large number of transactions or a large amount of inputted data to be used by the bypass offer program, the customer 202 or the manufacturer may be offered a personalized pricing at a reduced rate, due to their extended use of the program.

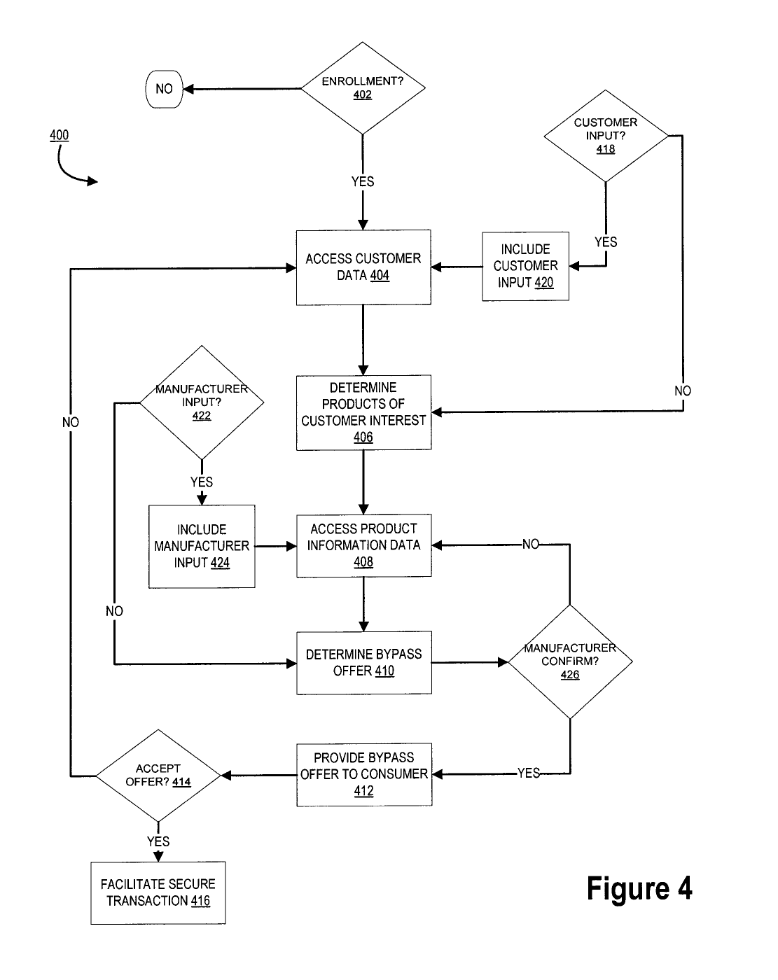

FIG. 4 illustrates a bypass offer program decision process flow 400 that provides customer 202 and manufacturer decisions with respect to the bypass offer program. In one embodiment the bypass offer program is initiated by the customer 202 enrolling in the bypass offer program 402. The enrollment may take place by the customer 202 completing the bypass offer interface 500. If the customer 202 chooses not to enroll, the bypass offer program decision process flow 400 is terminated. In one embodiment enrollment by the customer 202 may occur independent of completing the bypass offer interface 500. Once the customer 202 has enrolled in the bypass offer program, the bypass server application 234 may access customer data 404. Customer data may include financial institution acquired data provided by the financial institution data application 222 or customer data may be in the form of customer 202 input data. The customer 202 has the decision to input data at block 418. In one embodiment the customer 202 includes customer input data in the form of the bypass interface 500 input, survey data, questionnaire data, etc. the customer data may be included in the customer data accessed 404 by the bypass server application 234, in block 420. In one embodiment the customer 202 chooses not to include customer input data in block 418, the bypass offer program decision process flow 400 continues to determine products of customer interest 406 without customer input data.

Determining the products of customer interest 406 is calculated by the bypass server application 234 using the customer financial institution data and the customer inputted data. In one embodiment the products of customer interest 406 are determined by the financial institution data. In one embodiment the products of customer interest 406 are determined by the customer input data. In one embodiment the products of customer interest 406 are determined by the financial institution data and the customer input data.

As illustrated in FIG. 4, once products of customer interest are determined 406 the bypass server application 234 may access product information data 408. Product information data includes manufacturer financial institution data and manufacturer input data. The manufacturer has the decision to input data in decision block 422. In one embodiment the manufacturer includes input data into the bypass offer program in the form of manufacturer bypass offer interface 600, survey data, questionnaire data, etc. If the manufacturer includes input data into the bypass program, the next step is to determine a bypass offer 410. If the manufacturer provides input 422 then the bypass server application 234 may include manufacturer input data 424 in the bypass offer system. In one embodiment the manufacturer may not include manufacturer input data into the bypass system. If the manufacturer decides not to include input data, the system may continue to determine a bypass offer 410 with manufacturer financial institution data, which may include commercial accounts, product data, marketing strategies, transaction accounts, loans, mortgages, credit accounts, etc.

In one embodiment determining the bypass offer 410 may include calculating a compatibility of the customer's 202 interest in a product compared to products the manufacturers are offering through the bypass offer program. The compatibility is a comparison of the likelihood a customer 202 will purchase a product compared to the products availability from a manufacturer. In one embodiment the compatibility is calculated by the bypass server application 234 by incorporating the accessed customer data 404 and the accessed product information data 408.

Once a bypass offer is determined, the manufacturers of the products of the bypass offer are notified. The manufacturer may confirm the bypass offer in decision block 426. In one embodiment the manufacturer confirmation may be in the form of a confirmation bypass offer interface 700.

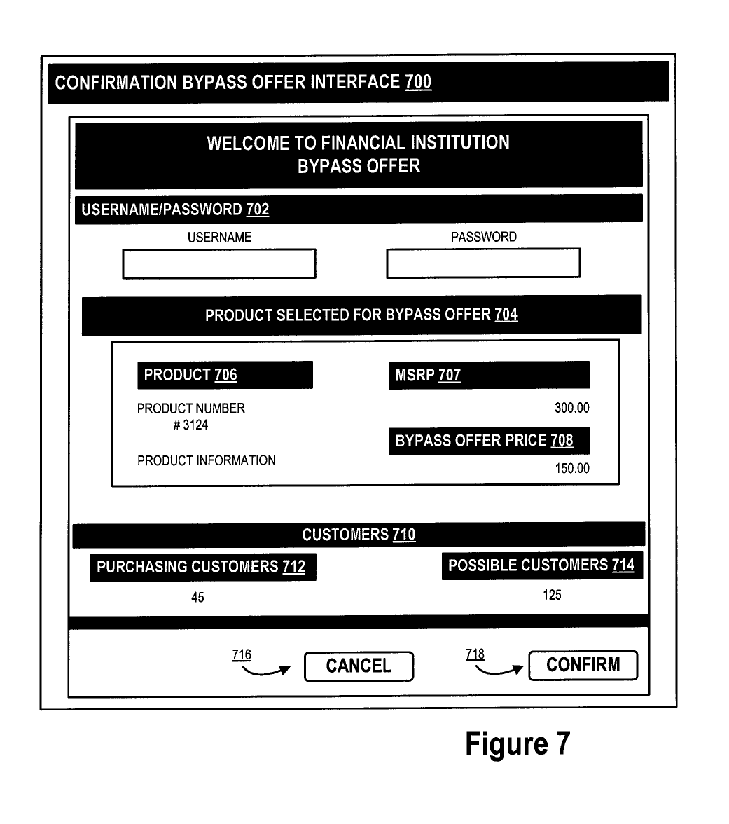

FIG. 7 illustrates a confirmation bypass offer interface 700. The confirmation bypass offer interface 700 allows a manufacturer to confirm the bypass offer prior to a customer 202 purchasing the product from the manufacturer. In this way, the manufacturer confirms the price of the product and confirms that the manufacturer still wishes to participate in the bypass offer program, prior to offering the bypass offer to a customer 202. The manufacturer may enter its username and password 702, the username and password may be the same as entered in the manufacturer bypass offer interface 600. Once the manufacturer enters its username and password, the products selected for the bypass offer 704 will be displayed on the interface. In one embodiment there will be one product displayed in the products selected for bypass offer section 704. In one embodiment there will be a plurality of products displayed in the products selected for bypass offer section 704. In one embodiment there will be no products displayed in the products selected for bypass offer section 704.

Within the product selected for bypass offer section 704 is information about the product being offered 706, the MSRP of the product 707, and the bypass offer price 708 of the product. The manufacturer can view the product it is providing to customers 202 through the bypass offer and ensure that the bypass offer price 708 is satisfactory. The next section of the confirmation bypass offer interface 700 is the customers section 710. Within the customers section 710 the manufacturer may view statistics regarding the products selected for the bypass offer 704. The statistics include the number of customers 202 that will purchase the product 712 and the number of customers 202 that may possibly purchase the product 714. For example, in the interface depicted the manufacturers product for the bypass offer 706 is product number #3124. The MSRP 707 for the product is 300.00 dollars and the bypass offer price 708 of 150.00 dollars. The customers section 710 shows that 45 customers 202 will purchase the product 712 and that 125 more customers 202 may possibly purchase the product 714.

Once the manufacturer has viewed the confirmation bypass offer interface 700, the manufacturer may either confirm or cancel the bypass offer by selecting confirm 718 or cancel 716 on the interface. As illustrated in block 422 of FIG. 4, in one embodiment the manufacturer cancels the bypass offer. In this situation the bypass offer program returns to the access product information data block 408 to process the product information data and determine a subsequent bypass offer. In one embodiment the manufacturer confirms the bypass offer. If the manufacturer confirms the bypass offer in block 426 the bypass offer is then provided to the customer 412. The customer 202 is provided the bypass offer by the bypass server application 234 provided bypass offer acceptance interface 800.

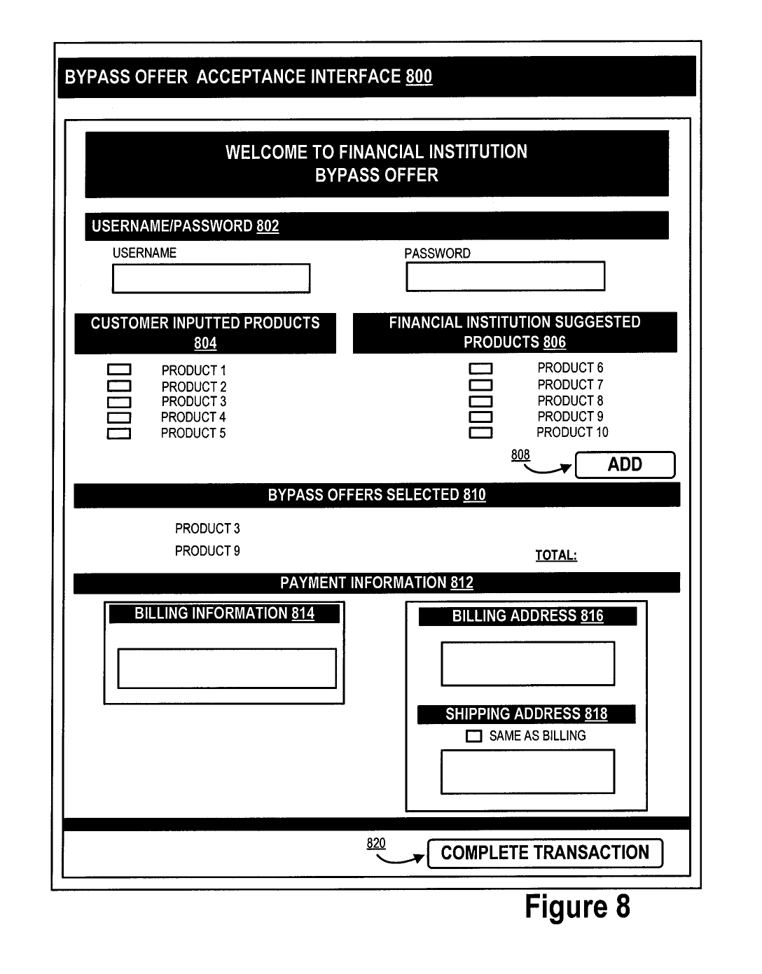

As illustrated in FIG. 8, the bypass offer acceptance interface 800 provides for customer 202 acceptance of a bypass offer product. To gain access to the bypass offer product the customer 202 may input a username and password 802, the username and password may be the same as the customer 202 provided in the bypass offer interface 500. After confirmation of the username and password, the customer 202 may select bypass offers available for purchase from both customer inputted products 804 and financial institution suggested products 806. Once the customer 202 has selected from the products provided, the customer 202 may choose to add the products for purchase by selecting add 808. After the customer 202 has selected to add 808 bypass offer products, the selected products are displayed in the bypass offers selected section 810. For example, the customer 202 may have selected two products for the bypass offer, in this example, product 3 and product 9. The products are displayed in the bypass offers selected section 810 along with the total cost of the products selected. The customer 202 may then provide payment information 812 for purchasing the bypass offer products. The customer 202 may provide billing information 814, a billing address 816, and a shipping address 818. If the customer 202 has completed the bypass offer acceptance interface 800, he may complete the transaction by selecting complete transaction 820. In one embodiment a fee for using the bypass program may be added to the product cost by the financial institution at this time. In one embodiment a fee for using the bypass program may be added at the time of enrollment into the bypass offer program. In one embodiment no fee for the use of the program may be added by the financial institution.

As illustrated in FIG. 4 at decision block 414 the customer 202 may accept the bypass offer provided by the bypass offer acceptance interface 800. If the customer 202 accepts the bypass offer then the bypass server application 234 facilitates a secure transaction 416 between the manufacturer and the customer 202. In one embodiment the customer 202 accepts one product from the bypass offer program. In one embodiment the customer 202 accepts a plurality of products from the bypass offer program. In one embodiment the customer 202 accepts no products from the bypass offer program. If the customer 202 does not accept the offer, in block 414, the bypass server application 234 accesses the customer data at block 404 and continues through the bypass offer program decision process flow 400.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a verity of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, etc.) that can direct a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method of promoting sales of products generally offered through distribution channels comprising:
receiving customer data associated with one or more customers obtained through interaction with the customers via a financial institution;
determining from the customer data, using a processing device, a potential interest by one or more of the customers in a given product; and
facilitating a transaction between the customer and a seller independent of the distribution channels for the product.

2. The method of claim 1 further comprising receiving information data associated with at least one of the products generally offered through distribution channels, wherein said determining a potential interest comprises using the information data to determine from the customer data potential interest by one or more customers in the given product.

3. The method of claim 1 further comprising determining an offer to the one or more customers based at least in part on the determined potential interest.

4. The method of claim 3, wherein said determining an offer comprises negotiating with a seller of the products a price, rebate, and/or discount.

5. The method of claim 1 further comprising charging a transaction fee to either one or both the customer and the seller of the products.

6. The method of claim 1, wherein distribution channels include distribution from a manufacture to a retailer with a plurality of possible intermediary steps.

7. The method of claim 6, wherein the plurality of possible intermediary steps is a distributor.

8. The method of claim 1, wherein the seller is one of a manufacturer of the product or an intermediate distributor of the product.

9. The method of claim 1, wherein the customer data is based on financial institution acquired data.

10. The method of claim 1, wherein the customer data is based on customer input.

11. The method of claim 2, wherein the information data is based on data acquired by interaction between the financial institution and the seller of the product.

12. The method of claim 2, wherein the information data is further based on seller input.

13. The method of claim 1, wherein determining the potential interest comprises determining from the customer data one or more products purchased previously by one or more customers.

14. The method of claim 1, wherein determining the potential interest further comprises determining from the customer data one or more products that one or more customers wish to purchase.

15. The method of claim 3, wherein said determining an offer to the one or more customers comprises calculating a compatibility of the customer data and the information data.

16. The method of claim 15, wherein the compatibility is a comparison of likelihood that the customer will purchase the product to products available from the seller.

17. The method of claim 1, wherein facilitating a transaction between the customer and the seller independent of the distribution channels includes:
receiving an offer from the seller; and
providing the offer to the one or more customers.

18. A system comprising:
a memory device;
a communication device; and
a processing device communicably coupled to the communication device and the memory device, wherein the communication device is configured to receive customer data associated with one or more customers obtained through interaction with the customers via a financial institution, and wherein the processing device is configured to:
determine from the customer data, using a processing device, a potential interest by one or more of the customers in a given product; and
facilitate a transaction between the customer and a seller independent of the distribution channels for the product.

19. The system of claim 18, wherein the communication device comprises computer-readable instructions embodied in a non-transitory computer-readable medium configured to receive information data associated with at least one of the products generally offered through distribution channels.

20. The system of claim 18, wherein the processing device is configured to determine a potential interest using the information data to determine from the customer data potential interest by one or more customers in the given product.

21. The system of claim 18, wherein the processing device is further configured to determine an offer to the one or more customers based at least in part on the determined potential interest, wherein determining an offer comprises negotiating with a seller of the products a price, rebate, and/or discount.

22. The system of claim 21, wherein the offer is stored in the memory device such that, for each offer to the one or more customers, a record is created of specific offer.

23. The system of claim 18 comprising charging a transaction fee to either one or both the customer and the seller of the products.

24. The system of claim 18, wherein distribution channels include distribution from a manufacturer to a retailer with a plurality of possible intermediary steps.

25. The system of claim 24, wherein the plurality of possible intermediary steps is a distributor.

26. The system of claim 18, wherein the seller of the product is a manufacturer.

27. The system of claim 18, wherein the customer data is stored in the memory device such that, for each customer of a plurality of customers, a record is created of specific purchase plans of the customer.

28. The system of claim 18, wherein the customer data is based on financial institution acquired data.

29. The system of claim 18, wherein the customer data is further based on customer input

30. The system of claim 19, wherein the information data is stored in the memory device such that, for each manufacturer of a plurality of manufacturers, a record is created of products and markets of the manufacturer.

31. The system of claim 19, wherein the information data is based on data acquired by interaction between the financial institution and the seller of the product.

32. The system of claim 19, wherein the information data is further based on seller input.

33. The system of claim 18, wherein the processing device is further configured to determine the potential interest by one or more customers in a given product at least in part by determining from the customer data one or more products purchased previously by one or more customers.

34. The system of claim 18, wherein the processing device is further configured to determine the potential interest by one or more customers in a given product at least in part by determining from the customer data one or more products that one or more customers wish to purchase.

35. The system of claim 18, wherein the processing device is further configured to determine the potential interest at least in part by calculating a compatibility of the customer data and the information data.

36. The system of claim 35, wherein the compatibility is a comparison of likelihood that the customer will purchase the product to products available from the seller.

37. The system of claim 18, wherein facilitating a transaction between the customer and the seller independent of the distribution channel includes:
the communication device configured to receive an offer from the seller; and
the processing device configured to provide the offer to the one or more customers.

38. A computer program product comprising at least one computer-readable medium having computer-readable program code portions embodied therein, the computer readable program code portions comprising:
an executable portion configured for receiving customer data associated with one or more customers obtained through interaction with the customers via a financial institution;
an executable portion configured for determining from the customer data a potential interest by one or more of the customers in a given product; and
an executable portion configured for facilitating a transaction between the customer and a seller independent of the distribution channels for the product.

39. The computer program product of claim 38 comprising an executable portion configured for receiving information data associated with at least one of the products generally offered through distribution channels, wherein said determining a potential interest comprises using the information data to determine from the customer data potential interest by one or more customers in the given product.

40. The computer program product of claim 38 comprising an executable portion configured for determining an offer to the one or more customers based at least in part on the determined potential interest.

41. The computer program product of claim 40, wherein said determining an offer comprises negotiating with a seller of the products a price, rebate, and/or discount.

42. The computer program product of claim 40 comprising an executable portion configured for calculating a compatibility of the customer data and the information data for determining an offer to the one or more customers, wherein the compatibility is a comparison of likelihood that the customer will purchase the product to products available from the seller.

43. The computer program product of claim 38 comprising an executable portion configured for charging a transaction fee to either one or both the customer and the seller of the products.

44. The computer program product of claim 38, wherein distribution channels include distribution from a manufacture to a retailer with a plurality of possible intermediary steps.

45. The computer program product of claim 43, wherein the plurality of possible intermediary steps is a distributor.

46. The computer program product of claim 38, wherein the seller is one of a manufacturer of the product or an intermediate distributor of the product.

47. The computer program product of claim 38, wherein the customer data is based on financial institution acquired data.

48. The computer program product of claim 38, wherein the customer data is based on customer input.

49. The computer program product of claim 39, wherein the information data is based on data acquired by interaction between the financial institution and the seller of the product.

50. The computer program product of claim 39, wherein the information data is further based on seller input.

51. The computer program product of claim 38 comprising an executable portion configured for determining the potential interest, wherein determining the potential interest comprises determining from the customer data one or more products purchased previously by one or more customers.

52. The computer program product of claim 38, wherein determining the potential interest further comprises determining from the customer data one or more products that one or more customers wish to purchase.

53. The computer program product of claim 38, wherein facilitating a transaction between the customer and the seller independent of the distribution channels comprises receiving an offer from the seller and providing the offer to the one or more customers.
